(19) United States
(12) Patent Application Publication
(10) Pub. No.: US 2009/0173724 A1
(43) Pub. Date: Jul. 9, 2009

(54) PRODUCT LASER IRRADIATION DEVICE, LASER IRRADIATION METHOD AND METHOD FOR MANUFACTURING MODIFIED OBJECT

(76) Inventors: Yoshiaki Ogino, Asigara-gun (JP); Katsumi Kimura, Asigara-gun (JP); Yasuhiro Iida, Kanagawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/295,551

(22) PCT Filed: Mar. 16, 2007
(86) PCT No.: PCT/JP2007/055430

§ 371 Date: Dec. 30, 2008

(30) Foreign Application Priority Data
Mar. 30, 2006 (JP) 2006-095754
Sep. 15, 2006 (JP) 2006-250408

(51) Int. Cl. B23K 26/06

(52) U.S. Cl. 219/121.75

(57) ABSTRACT

Provided are a laser irradiation device and a laser irradiation method, which are suitable for a liquid crystal display device. The laser irradiation device comprises a semiconductor laser element group (1A) having a plurality of semiconductor laser elements (1) arranged therein for emitting laser beams of a wavelength of 370 nm to 480 nm, optical fibers (2) for transmitting the laser beams emitted from the semiconductor laser elements (1), a straight bundle (3) for holding the optical fibers (2) straight, an optical adjustor (4) for shaping the laser beams outputted from the optical fibers held by the straight bundle (3), into a linear shape and for smoothing the top of the laser intensity distribution thereby to output the smoothed laser beams, and an objective lens (5) for condensing the laser beams outputted from the optical adjustor (4), as a linear laser spot on an object The semiconductor laser element group (1A) has a total irradiation output value of 6 W to 100 W.

### TECHNICAL FIELD

The present invention relates to a laser irradiating device, laser irradiating method and method of manufacturing modified objects which are adapted to production systems of flat display devices. More particularly, the present invention relates to a laser irradiating device, laser irradiating method and method of manufacturing modified objects which are adapted to production systems of flat display devices in which a silicon layer is modified by irradiating laser beams on amorphous silicon or polysilicon (polymorphous silicon) formed on an insulating substrate.

### BACKGROUND ART

In recent years, liquid crystal element is used as the display element in display devices. The liquid crystal element (pixel element) and its driver circuit are generally made of thin film transistor (hereinafter referred to as “TFT”). In the manufacturing of TFT, a process to modify amorphous silicon formed on a glass substrate into polysilicon. The meaning of the term “modify” used throughout in this specification is not limited to changing amorphous silicon into polysilicon but generally includes changing physical characteristics of a substance.

In the above-mentioned modifying process, a silicon layer is modified by irradiating laser beams thereon. As shown in FIG. 9, the modifying process includes
step of forming an undercoating layer (SiO₂) 73 on an insulating substrate 72 for protecting the substrate 72 from impurities,
step of forming an amorphous silicon layer surface 74 on the undercoating layer 73,
step of irradiating linear laser beams 75 on the amorphous silicon layer surface 74 using a high-power laser beam source,
step of scanning the linear laser beams 75 (in the direction of 74A) to modify the amorphous silicon layer surface 74 into polysilicon 74B,
step of removing polysilicon on the positions where TFTs are to be formed,
step of forming gate oxide film (SiO₂) on the positions cleared of polysilicon and providing gate electrodes thereon,
step of injecting impurity ions into the insulating layer (SiO₂) to form source/drain regions, and
step of providing aluminum electrodes on the source/drain regions and coating with a protection layer, thereby forming TFTs. SiN or SiON may be disposed between the insulating substrate 72 and the undercoating layer 73.

In the above-mentioned modifying process of silicon layer by irradiating laser beams, generally employed is excimer laser annealing using excimer laser. In excimer laser annealing, a polysilicon layer is formed by irradiating on a silicon layer XeCl excimer laser beams with a pulse width of tens nS and with a wave length of 307 nm, which has a high optical absorption efficiency, and heating the silicon layer immediately up to the melting temperature by injecting comparatively low energy of 160 mJ/cm². Excimer laser has such characteristics that it has such a high output as several hundred watt, it can form a large-size linear laser spot with a length larger than that of a longitudinal side of a rectangular mother glass substrate and it can efficiently modify the whole surface of a silicon layer formed on a mother glass at once. In the modification of a silicon layer using excimer laser beams, the particle size of polysilicon, which critically affects the performance of TFT, becomes as small as 100 nm to 500 nm while the electric field effect mobility, which is indicative of the performance of TFT, remains as low as 150 cm²/VS.

Proposed in recent years is a system on glass having control circuits, interface circuits and also high-performance circuits such as arithmetic circuits as well as pixels and driver circuits on a flat display, and it is already developed partially. It is requested to provide a high performance TFT to form the high-performance circuits. To provide a high performance TFT, it is necessary to conduct a high quality polysilicon modification (which means the crystal sizes need to be large enough). The below listed prior art documents disclose techniques to conduct a high quality polysilicon modification.

The Patent document 1 discloses a technique to form a high quality amorphous silicon extending in a bar shape in the scanning direction layer with large crystal sizes by scanning laser beam irradiation on a silicon layer while irradiating with continuous wave (CW) using solid-state laser as a light source and a technique to preliminarily pattern amorphous silicon into a linear shape (ribbon shape) or an island shape on the positions where TFTs are to be formed so as to obtain electric field effect mobility of 300 cm²/VS or larger, thereby forming high performance TFTs.

The Patent document 2 discloses preferable relationship between the width in the scanning direction of the linear laser spot formed on the silicon layer and the scanning speed in order to form large size crystal particles extending in a bar shape in the scanning direction using continuous wave solid-state laser beams for semiconductor excitation. The solid-state laser mentioned in these documents is a second harmonic solid-state Nd:YVO₄ laser having a wavelength of 532 nm.

Patent document 1: Japanese Patent Laid-open No. 2003-86585 (Tokkai 2003-86585)

Patent document 2: Japanese Patent Laid-open No. 2005-217214 (Tokkai 2005-217214)

### DISCLOSURE OF THE INVENTION

### Problems To Be Solved By the Invention

The above-mentioned excimer laser annealing, however, has such problems that laser output often becomes unstable which makes it difficult to modify a silicon layer evenly and, thus, the performance of the TFTs tends to be inconsistent. There are furthermore problems that aging deterioration of the laser oscillating tubes, optical components and infill gases makes it necessary to implement frequent maintenance for preventing occurrence of modification inconsistency, which result in reduction of productivity due to loss of stability, loss of serviceability and running costs of the devices. Also, the devices needs to be large-scale.

On the other hand, the device using solid-state laser beams for semiconductor excitation mentioned in the above has such a problem that the optical output is relatively low with respect to the power consumption of the device and light conversion efficiency is not enough because it uses second harmonic solid-state laser. Furthermore, the device using solid-state laser beams uses laser beams with a wavelength of 532 nm, which is far different from the peak value (approximately 300 nm) for optical absorption of silicon. This means that energy conversion efficiency is undesirably low because optical energy absorption of the silicon layer is low and the modification energy of silicon is relatively low with respect to the power consumption of the device.

In view of the foregoing, it is an object of the present invention to provide a laser irradiating device, laser irradiating method and method of manufacturing modified objects which makes it possible to modify a silicon layer with high stability of output and maintainability and with less space and running cost.

### Means For Solving the Problems

In order to achieve the objective of the present invention, the present invention provides a laser irradiating device comprising a semiconductor laser element assembly having a plurality of first semiconductor laser elements emitting laser beams of a wavelength of 370 to 480 nm, said semiconductor laser element assembly irradiating a linear laser spot having a total irradiation output volume of 6 W or more and 100 W or less.

The laser irradiating device of the present invention further comprises optical fibers transmitting laser beams emitted from said first semiconductor laser elements, a linear bundle aligning and retaining said optical fibers on a line parallel to the longitudinal direction, an optical compensator shaping the laser beams emitted from said optical fibers into a linear form, flattening the laser intensity distribution of the laser beams and emitting the laser beams, and an objective lens collimating the laser beams emitted from said optical compensator to form a linear laser spot.

In the above laser irradiating device, said optical compensator and said objective lens operates such that a linear laser spot having a lateral length of 1 to 30 um and a longitudinal length of 1 to 30 mm is formed on the object.

The laser irradiating device of the present invention further comprises focus error signal generating means generating focus error signals based on the laser beams returned from the linear laser spot irradiated on the object and an objective lens driving circuit driving said objective lens in the direction perpendicular to the surface of the object.

In the above laser irradiating device, said focus error signal generating means comprises second semiconductor laser elements emitting focusing laser beams having a wavelength of 500 to 900 nm.

The laser irradiating device of the present invention further comprises laser intensity distribution detecting means disposed the light path of said linear laser spot to detect laser intensity distribution of said linear laser spot, a laser driver regulating the laser output volume of said first semiconductor laser elements and controlling means controlling said laser driver such that the laser intensity distribution detected in said laser intensity distribution detecting means falls within a predetermined range.

In the above laser irradiating device, said controlling means comprises a pulse output controlling function to control said first semiconductor laser elements to output pulsed laser beams, said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

The laser irradiating device of the present invention further comprises laser spot rotating means rotating the linear laser spot irradiated on the object within an angle range of 0 to 90 degrees.

The laser irradiating device of the present invention further comprises scanning means scanning the linear laser spot irradiated on the object relatively with respect to the surface of the object.

In the above laser irradiating device, the object is a thin film transistor for a display in which amorphous silicon formed on a glass substrate is modified into polysilicon.

The present invention further provides a laser irradiating method for modifying an object by irradiating thereon linear laser spot emitted from a laser irradiating device comprising a semiconductor laser element assembly having a plurality of first semiconductor laser elements emitting laser beams of a wavelength of 370 to 480 nm, wherein said semiconductor laser element assembly irradiates a linear laser spot having a total irradiation output volume of 6 W or more and 100 W or less.

In the above laser irradiating method, said laser irradiating device further comprises optical fibers transmitting laser beams emitted from said first semiconductor laser elements, a linear bundle aligning and retaining said optical fibers on a line parallel to the longitudinal direction, an optical compensator shaping the laser beams emitted from said optical fibers into a linear form, flattening the laser intensity distribution of the laser beams and emitting the laser beams, and an objective lens collimating the laser beams emitted from said optical compensator to form a linear laser spot, said optical fibers transmitting laser beams emitted from said first semiconductor laser elements to said optical compensator by way of said optical fibers retained by said linear bundle, said optical compensator shaping the laser beams emitted from said optical fibers into a linear form, flattening the laser intensity distribution of the laser beams and emitting the laser beams to said objective lens, said objective lens collimating the laser beams emitted from said optical compensator to form a linear laser spot, whereby the object is modified.

In the above laser irradiating method, said optical compensator and said objective lens operates such that a linear laser spot having a lateral length of 1 to 30 um and a longitudinal length of 1 to 30 mm is formed on the object, whereby the object is modified.

In the above laser irradiating method, said laser irradiating device further comprises focus error signal generating means generating focus error signals based on the laser beams returned from the linear laser spot irradiated on the object and an objective lens driving circuit driving said objective lens in the direction perpendicular to the surface of the object, said laser irradiating device further comprises focus error signal generating means generating focus error signals based on the laser beams returned from the linear laser spot irradiated on the object, said objective lens driving circuit driving said objective lens in the direction perpendicular to the surface of the object, whereby the object is modified.

In the above laser irradiating method, said laser irradiating device further comprises focus error signal generating means having second semiconductor laser elements, said focus error signal generating means operates to control the focusing using the focusing laser beams having a wavelength of 500 to 900 nm emitted by said second semiconductor laser elements, whereby the object is modified.

In the above laser irradiating method, said laser irradiating device further comprises laser intensity distribution detecting means disposed the light path of said linear laser spot to detect laser intensity distribution of said linear laser spot, a laser driver regulating the laser output volume of said first semiconductor laser elements and controlling means controlling said laser driver such that the laser intensity distribution detected in said laser intensity distribution detecting means falls within a predetermined range, said laser intensity distribution detecting means detecting laser intensity distribution of said linear laser spot, the laser driver regulating the laser output volume of said first semiconductor laser elements, said controlling means controlling said laser driver such that the laser intensity distribution detected in said laser intensity distribution detecting means falls within a predetermined range, whereby the object is modified.

In the above laser irradiating method, said laser irradiating device further comprises a pulse output controlling function to control said first semiconductor laser elements to output pulsed laser beams, said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

In the above laser irradiating method, said laser irradiating device further comprises laser spot rotating means rotating the linear laser spot irradiated on the object within a predetermined angle range, said laser spot rotating means rotating the linear laser spot irradiated on the object within an angle range of 0 to 90 degrees, whereby the object is modified.

In the above laser irradiating method, said laser irradiating device further comprises scanning means scanning the linear laser spot irradiated on the object relatively with respect to the surface of the object, said scanning means scanning the linear laser spot irradiated on the object relatively with respect to the surface of the object, whereby the object is modified.

In the above laser irradiating method, the object is a thin film transistor for a display in which amorphous silicon formed on a glass substrate is modified into polysilicon.

The present invention further provides a manufacturing method for manufacturing an object by irradiating laser beams thereon, wherein using a semiconductor laser element assembly having a plurality of first semiconductor laser elements emitting laser beams of a wavelength of 370 to 480 nm, said semiconductor laser element assembly irradiating a linear laser spot having a total irradiation output volume of 6 W or more and 100 W or less, whereby the object is modified.

In the above manufacturing method, using optical fibers transmitting laser beams emitted from said first semiconductor laser elements, a linear bundle aligning and retaining said optical fibers on a line parallel to the longitudinal direction, an optical compensator shaping the laser beams emitted from said optical fibers into a linear form, flattening the laser intensity distribution of the laser beams and emitting the laser beams, and an objective lens collimating the laser beams emitted from said optical compensator to form a linear laser spot, said optical fibers transmitting laser beams emitted from said first semiconductor laser elements to said optical compensator by way of said optical fibers retained by said linear bundle, said optical compensator shaping the laser beams emitted from said optical fibers into a linear form, flattening the laser intensity distribution of the laser beams and emitting the laser beams to said objective lens, said objective lens collimating the laser beams emitted from said optical compensator to form a linear laser spot.

In the above manufacturing method, said optical compensator and said objective lens operates such that a linear laser spot having a lateral length of 1 to 30 um and a longitudinal length of 1 to 30 mm is formed on the object.

In the above manufacturing method, using focus error signal generating means generating focus error signals based on the laser beams returned from the linear laser spot irradiated on the object and an objective lens driving circuit driving said objective lens in the direction perpendicular to the surface of the object, said laser irradiating device further comprises focus error signal generating means generating focus error signals based on the laser beams returned from the linear laser spot irradiated on the object, said objective lens driving circuit driving said objective lens in the direction perpendicular to the surface of the object.

In the above manufacturing method, said laser irradiating device further comprises focus error signal generating means having second semiconductor laser elements having a wavelength of 500 to 900 nm, said focus error signal generating means operates to control the focusing using the focusing laser beams having a wavelength of 500 to 900 nm emitted by said second semiconductor laser elements.

In the above manufacturing method, said laser irradiating device further comprises laser intensity distribution detecting means disposed the light path of said linear laser spot to detect laser intensity distribution of said linear laser spot, a laser driver regulating the laser output volume of said first semiconductor laser elements and controlling means controlling said laser driver such that the laser intensity distribution detected in said laser intensity distribution detecting means falls within a predetermined range, said laser intensity distribution detecting means detecting laser intensity distribution of said linear laser spot, the laser driver regulating the laser output volume of said first semiconductor laser elements, said controlling means controlling said laser driver such that the laser intensity distribution detected in said laser intensity distribution detecting means falls within a predetermined range.

In the above manufacturing method, said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

In the above manufacturing method, said laser irradiating device further comprises laser spot rotating means rotating the linear laser spot irradiated on the object within a predetermined angle range, said laser spot rotating means rotating the linear laser spot irradiated on the object within an angle range of 0 to 90 degrees.

In the above manufacturing method, said laser irradiating device further comprises scanning means scanning the linear laser spot irradiated on the object relatively with respect to the surface of the object, said scanning means scanning the linear laser spot irradiated on the object relatively with respect to the surface of the object.

In the above manufacturing method, the object is a thin film transistor for a display in which amorphous silicon formed on a glass substrate is modified into polysilicon.

The present invention further provides a laser irradiating device for modifying amorphous silicon layer having a depth by irradiating laser beams thereon comprising a semiconductor laser element assembly having a plurality of semiconductor laser elements emitting laser beams having an optical penetration depth substantially equivalent to the depth of said amorphous silicon layer, said semiconductor laser element assembly irradiating a linear laser spot having a total irradiation output volume of 6 W or more and 100 W or less.

The present invention further provides a laser irradiating method using a laser irradiating device for modifying amorphous silicon layer having a depth by irradiating laser beams thereon wherein, said laser irradiating device comprises a semiconductor laser element assembly having a plurality of semiconductor laser elements emitting laser beams having an optical penetration depth substantially equivalent to the depth of said amorphous silicon layer, said semiconductor laser element assembly irradiating a linear laser spot having a total irradiation output volume of 6 W or more and 100 W or less on the amorphous silicon layer.

The present invention further provides a manufacturing method for manufacturing an object having a layer depth by modifying said object by irradiating laser beams thereon, wherein using a semiconductor laser element assembly having a plurality of semiconductor laser elements emitting laser beams having an optical penetration depth substantially equivalent to the depth of said amorphous silicon layer, said semiconductor laser element assembly irradiating a linear laser spot having a total irradiation output volume of 6 W or more and 100 W or less on the object.

### Effect of the Invention

Thus, the present invention provides a laser irradiating device and laser irradiating method, in which a target object is modified using a linear laser spot with a wavelength of 370 nm to 480 nm and a total irradiation output of 6 W to 100 W emitted from a plurality of semiconductor laser element, thereby achieving high stability of output, easiness of output control, high light conversion efficiency and downscaling. The laser irradiating device and laser irradiating method of the present invention, in which a target object such as amorphous silicon layer is irradiated with laser beams having a penetration depth equivalent to the thickness of the silicon layer, advantageous in that crystal growth in the depth direction of the silicon layer is controlled while crystal growth in the planer direction of the silicon layer is facilitated.

### Best Mode For Carrying Out the Invention

An embodiment of the laser irradiating device employing the laser irradiating method and the method of manufacturing modified objects of the present invention will be below described in detail with reference to the drawings. FIG. 1 is a view of the basic construction of the laser irradiating device of the present invention. FIG. 2 is a view showing focus control system of the laser irradiating device of the present invention. FIG. 3 is a view showing spot rotating operation of the laser irradiating device of the present invention. FIG. 4 is a view showing the laser intensity distribution and laser output control of the laser irradiating device of the present invention. FIG. 5 is a view showing method of controlling the laser intensity distribution of the laser irradiating device shown in FIG. 4. FIG. 6 is a view showing method of irradiating laser beams in the laser irradiating device of the present invention. FIG. 7 is a view showing the relationship between the display and the laser scanning position. FIG. 8 is a view showing a system on glass. FIG. 9 is a view showing a general construction of a substrate and modification of a silicon layer by laser irradiation.

### Basic Construction of First Embodiment

As shown in FIG. 1, the laser irradiating device of the present embodiment comprises a semiconductor laser element assembly 1A consisting of a plurality of semiconductor laser elements 1, optical fibers 2 guiding laser beams emitted from the semiconductor laser elements 1, receptacle modules (or connectors) focusing the laser beams into the optical fibers 2 (not shown), a linear bundle 3 aligning the optical fibers 2 in parallel with their longitudinal direction, an optical compensator 4 and an objective lens 5 laser beams emitted from the optical compensator 4.

The semiconductor laser elements 1, for example, each emits blue laser beams with a wavelength of 370 nm to 480 nm and output of several hundred W. Because the semiconductor laser elements 1 are small-sized, it is possible to use a plurality of semiconductor laser elements 1 according to the required output.

The receptacle modules are arranged in the vicinity of the emitters of the semiconductor laser elements 1 so as to focus the laser beams into the optical fibers 2, preferably with a high coupling efficiency. The optical fibers 2 has such characteristics that they efficiently transmit laser beams having a wavelength of 370 nm to 480 nm and have small core diameter, preferably 50 um or less. The linear bundle 3 is employed to align the ends of the optical fibers 2. The linear bundle 3 has a function to arrange the optical fibers 2 tightly with or closely to each other, a function to arrange the central axes of the optical fibers 2 into and accurately parallel position with each other and a function to arrange the end faces of the optical fibers 2 into an accurate alignment in the direction perpendicular to the central axes of the optical fibers 2.

The optical compensator 4 has a function to flatten the laser intensity distribution in the longitudinal direction of the laser beams 6 emitted from the ends of the bundled optical fibers 2 and a function to shape the beams such that the laser spot on the silicon layer (not shown) has a predetermined width d in the lateral direction. The optical compensator 4 may be made of a homogenizer having a plurality of cylindrical lenses. The objective lens 5 focuses the laser beams 7 emitted through the optical compensator 4 onto the silicon layer (not shown). The optical components used in the laser irradiating device of the present embodiment are designed to produce laser beams of the blue wavelengths (370 nm to 480 nm) with high characteristics.

The laser irradiating device constructed as in the above can form a flattened linear laser spot 8 of blue wavelengths (370 nm to 480 nm) with a high power density and surely focus it onto the silicon layer (not shown) by aligning a plurality of blue semiconductor laser elements 1 each having a comparatively low output. It is preferable that the linear laser spot 8 has a lateral width d of 1 um to 30 um and a longitudinal width L of 1 mm to 30 mm. The shape of the linear laser spot 8 can be adjusted by the optical compensator 4 and the objective lens 5.

It is preferable that the total irradiation output of the laser beams is 6 W to 100 W. The total irradiation output of the laser beams is preferably 6 W or more because the light absorption efficiency when using the blue semiconductor laser elements having wavelengths of 370 nm to 480 nm is about six times higher than the light absorption efficiency when using a solid-state green laser, which means that the blue semiconductor laser elements provide six times higher light energy for modifying the silicon layer. The total irradiation output of the laser beams is preferably 100 W or less because excessively high laser power causes the silicon layer surface to be rougher, causes the silicon layer to be stripped and gives heat damage to the undercoat layer.

The laser wavelength is preferably 480 nm or less because the light penetration depth of light having a wavelength of about 480 nm on amorphous silicon is about 50 nm. When the laser wavelength is 480 nm or less, it is possible to regulate crystal (microcrystal) growth in the depth direction of the silicon layer and facilitate crystal growth in the lateral direction (the planer direction of the silicon layer), thereby allowing the silicon layer to efficiently absorb light so as to efficiently generate large-scale crystals.

When the laser wavelength is preferably 481 nm or more, it is considered that the heating efficiency (crystallization efficiency) of the silicon layer becomes significantly low because the irradiating beams pass through the silicon layer. This means that the laser wavelength can be adjusted according to the depth of the silicon layer. The upper limit of the laser wavelength will be more than 480 nm in case the depth of the silicon layer is more than 50 nm whereas the upper limit of the laser wavelength will be less than 480 nm in case the depth of the silicon layer is less than 50 nm.

Thus, in the present embodiment, the laser wavelength should be determined according to the depth of the silicon layer. For example, a laser wavelength of about 370 nm is suitable for a silicon layer having a depth of about 17 nm. In the present invention, a laser wavelength is “suitable” when the light penetration depth is within the range of 50% above or below of the silicon layer depth, in which case the laser beams reach the bottom face of the silicon layer so as to regulate crystal (microcrystal) growth in the depth direction of the silicon layer and facilitate crystal growth in the lateral direction (the planer direction of the silicon layer).

The above-mentioned laser irradiating device scans the linear laser spot on the silicon layer in the lateral direction. It is predicted that, in case the lateral width d of the linear laser spot 8 becomes larger, irradiating time becomes longer and the silicon layer will be stripped and damaged, or the laser power density becomes lower and modification process is deteriorated.

Accordingly, in the present embodiment, the lateral width d of the linear laser spot 8 is preferably 1 um to 30 um while the longitudinal width L may be determined depending on the width of the high-performance circuits. The longitudinal width L of the linear laser spot 8 is preferably 1 mm to 30 mm.

### Basic Construction of Second Embodiment

FIG. 2 is a view showing the focus controlling system of the laser irradiating device of the present invention. This laser irradiating device is basically constructed in the same way as the laser irradiating device shown in FIG. 1. This laser irradiating device comprises a semiconductor laser element assembly 9A consisting of a plurality of semiconductor laser elements 9, optical fibers 10 guiding laser beams emitted from the semiconductor laser element assembly 9A, a linear bundle 11 for aligning the optical fibers 10, an optical compensator 12 having functions to flatten the laser intensity distribution in the longitudinal direction of the laser beams and to collimate the beams in each direction, an objective lens 13 and the focus controlling system. The above-mentioned members have similar functions to those in the laser irradiating device shown in FIG. 1.

The focus controlling system of the present embodiment comprises a focusing laser element 14, a collimating lens 15 shaping laser beams 23 into parallel light beams 24, a polarized beam splitter 16 splitting the returned light, a quarter wavelength plate (not shown), a wavelength splitting plate 24A, a beam splitter 17, convex lens 18, a focus signal generator 19, a phase compensating circuit 20, an objective lens 13, a voice coil motor (hereinafter referred to as “VCM”) 22 for driving the objective lens 13 in the direction of the arrow 25 and a VCM driver 21.

The focusing laser element 14 of the present embodiment is preferably made of a semiconductor laser element having a wavelength of 650 nm such that it has a different wavelength from the blue wavelength (370 to 480 nm) of the main laser system 26. However, the focusing laser element 14 may be made of a semiconductor laser element having a green or red wavelength in the range of 500 to 900 nm.

The wavelength splitting plate 24A transmits laser beams having a red wavelength (650 nm) and reflects laser beams having a blue wavelength (370 to 480 nm) However, other kind of wavelength splitting plate may be employed as long as it selectively transmits laser beams having the same wavelength as the focusing laser element 14 and reflects a blue wavelength (370 to 480 nm). Thus, the focusing laser beams can be extracted from the light beams mingled with main laser beams.

The focus signal generator 19 generates focus error signals 23 upon receiving the returned laser beams 29 which is the focusing beams (650 nm) 27 reflected on the silicon layer surface and traveled through the objective lens 13, the beam splitter 17, the wavelength splitting plate 24A, the quarter wavelength plate (not shown), the polarized beam splitter 16 and the convex lens 18. By the focus error signals 23, it is possible to detect the defocus of the main linear laser beams 28 on the silicon layer.

Although the focusing laser element 14 emits laser beams having a wavelength different from that (blue wavelength of 370 to 480 nm) of the main laser system 26 in the above description, the focusing laser element 14 may emit laser beams having the same wavelength as the main laser system 26 as long as the reflected beams from the silicon layer surface can be extracted and used for generating the focus error signals. In such a case, the wavelength splitting plate 24A can be excepted.

The VCM driver 21 drives the objective lens 13 mounted on the VCM 22 in the direction of the arrow 25. The phase compensating circuit 20 regulates the focus servo operation to enable automatic stable auto-focusing control based on the focus error signals (focus sensitivity) from the focus signal generator 19 and the f-characteristics of the VCM. Thus, it is possible to prevent the linear laser beams 28 from being deformed and stabilize the silicon modification process even in case the distance between the silicon layer and the device relatively varies. Although the VCM 22 is employed as means for driving the objective lens 13 in the direction of the arrow 25 in this embodiment, other means may be used as the driving source, such as piezoelectric elements which generate power by applying voltage.

### Spot Rotation

FIG. 3 is a view showing the spot rotation of the laser irradiating device of the present embodiment. Shown in FIG. 3 is the shape of the linear laser spot formed on the silicon layer (not shown) viewed from the direction perpendicular to the silicon layer surface. By rotating the spot rotator 30 shown in FIG. 2 around the optical axis, the linear laser spot 32 can be rotated in the angle range of 0 to 90 degree. The effect of the spot rotation will be explained below.

### Detection of Laser Intensity Distribution And Regulation of Laser Output

FIG. 4 is a view showing the detection of the laser intensity distribution and the regulation of the laser output in the laser irradiating device of the present invention. The laser irradiating device shown in FIG. 4 has similar constructions to those in the laser irradiating device shown in FIG. 1. The laser irradiating device shown in FIG. 4 comprises semiconductor laser elements 34, optical fibers 35, a linear bundle 36, an optical compensator 37, an objective lens 38 and laser intensity distribution detecting means consisting of a beam splitter 39, a collimating lens 40 and a line sensor 41.

The beam splitter 39 reflects several percents of the total light volume of the light directed to the objective lens 38 toward the collimating lens. The line sensor 41 comprises a plurality of light intensity detector having sizes of tens of um in a linear alignment so as to detect the laser intensity distribution in the longitudinal direction of the linear laser beams collimated by the collimating lens 40. The line sensor 41 also has a function to convert the detected laser intensity distribution into electronic signals. The microprocessor 42 has an A/D converting function to convert the electronic signals outputted by the line sensor 41 into digital data, a computing function to compare the digital data with predetermined digital data, a memory function and a controlling function to control the output volumes of each of the semiconductor laser elements respectively.

The laser driver 43 drives the semiconductor laser elements in accordance with the instruction from the microprocessor. Or else, the line sensor 41 may have an A/D converting function and send digital data to the microprocessor 42.

It is preferable that the intensity distribution in the longitudinal direction of the linear laser spot detected by the line sensor 41 conforms with the intensity distribution in the longitudinal direction of the linear laser spot formed on the silicon layer, but they may not be the same. Although a one dimension line sensor is employed in the present embodiment, a two dimension CCD may be used. All that is required is that the intensity distribution information of the linear laser spot is transmitted to the microprocessor 42.

### Method of Controlling Laser Intensity Distribution

FIG. 5 is a view showing the method of controlling laser intensity distribution in the laser irradiating device shown in FIG. 4. Shown in FIG. 5, in which the lateral axis indicates the longitudinal direction of the linear laser spot and the vertical axis indicates the laser output, is the laser intensity distribution detected by the line sensor 41.

In FIG. 5, shown are the laser intensity distributions on the line sensor 41 corresponding to the longitudinal intensity distribution of the linear laser spot formed on the silicon layer (a) in case the linear laser spot formed on the silicon layer is most favorable and (b) in case the linear laser spot formed on the silicon layer is deteriorated. When the linear laser spot formed on the silicon layer is favorable, the top part of the intensity distribution is flat and wide. With such a linear laser spot, it is possible to irradiate even laser beams onto the silicon layer and to reduce silicon modification blotches.

Blow explained is the method of controlling the laser intensity distribution in the present embodiment. First, the microprocessor 42, readily storing the laser intensity distribution 44 in FIG. 5(a) in the memory, compares the laser intensity distribution 45 detected by the line sensor 41 with the laser intensity distribution 44 and controls the output of the semiconductor laser elements respectively such that the laser intensity distribution 45 conforms with the laser intensity distribution 44. At the same time, the microprocessor 42 controls the output of the semiconductor laser elements respectively such that the laser intensity distribution 45 has a predetermined area size which corresponds to the predetermined laser intensity. This is because the total output of the laser beams is proportional to the area size of laser intensity distribution.

In the present embodiment, a stable laser intensity distribution can be obtained even in case the property of the semiconductor laser elements are varied. It is also possible to detect deterioration of the semiconductor laser elements 34 by setting a threshold for the adjusting value with respect to the laser intensity distribution 44.

### Controlling of Laser Output

The microprocessor 42 of the above embodiment controls the output such that the output volume of the laser beams emitted from the semiconductor laser elements 34 is constant over time. The microprocessor 42 in the present invention, however, may has a pulsed output controlling function to control the semiconductor laser elements 34 to output continually over time. This microprocessor 42 having the pulsed output controlling function preferably operates such that laser driver 43 drives the semiconductor laser elements 34 to emit pulses with frequencies of 0.1 to 5 MHz, pulse duty ratios of 10% to 90% and the ratio of the pulse top output (Pt) and the pulse bottom output (Pb) being 50% or less.

The pulse duty ratio is the ratio (Tt/T×100) of the pulse top output time (Tt) and the pulse period (T). This pulsed output controlling function cannot be provided by the prior art excimer laser elements or solid-state laser elements, but can only be provided by the semiconductor laser elements.

The pulse frequency is set to be 0.1 to 5 MHz because the irradiating spots (pulse top output) overlap each other within the lateral spot width of 1 to 30 um and the silicon layer can be closely irradiated as the laser spot scans on the silicon layer in the lateral direction of the laser spot at a scanning speed of 100 mm/s to 3 m/s. The pulse duty ratio is set to be 10% to 90% so as to be able to regulate the irradiating energy onto the silicon layer. The ratio of the pulse top output (Pt) and the pulse bottom output (Pb) is set to be 50% or less such that the silicon layer is molten by the pulse top output (Pt) while the silicon layer is not molten by the pulse bottom output (Pb).

The microprocessor 42 having the pulsed output controlling function can reduce damage, overheat and sublimation on the silicon layer because the energy irradiated on the silicon layer is moderated in scanning the laser spot irradiating on the silicon layer surface. The microprocessor 42 also enables crystallization with a desired crystal size because it can control the crystal growth by setting the conditions such as the scanning speed of the laser spot, the laser pulse frequency, the pulse duty ratio, the pulse top output and the pulse bottom output.

### Laser Irradiation Method And Manufacturing Method

Now, with reference to FIG. 6, the laser irradiating method and manufacturing method of modifying amorphous silicon formed on a glass substrate of a liquid crystal display into polysilicon using the laser irradiating device of the above-described present embodiment will be described.

In the present laser irradiating method, an insulating substrate 46 formed with silicon layer is placed on an X-Y stage 47. The X-Y stage 47 is capable of being placed at desired X-Y position and being moved at desired speed in the X direction and the Y direction. One of the laser irradiating devices (shown in FIGS. 1 to 4) 48 is used to irradiate laser beams to form a linear laser spot 50 on the silicon layer surface. The X-Y stage 47 is controlled such that the linear laser spot 50 scans at a predetermined speed in the lateral direction of the linear laser spot 50.

Then, in the present laser irradiating method, the linear laser spot 50 scans in the Y direction (51) with the longitudinal direction of the linear laser spot 50 being parallel to the X direction. When scanning in the X direction at the predetermined speed, the spot is rotated as shown in FIG. 3. Thus, in the present laser irradiating method, the laser spot can be easily rotated without necessitating it to rotate the laser irradiating device 48 itself.

Although the insulating substrate 46 is moved to rotate and scan the spot 50 in the above present laser irradiating method, it is also possible to move the laser irradiating device 48 relatively in the X direction and the Y direction to scan the spot 50. In this case, the semiconductor laser element assembly 1A, 9A or 34A may be fixedly disposed such that only the optical system down the linear bundle is made movable in the laser irradiating device 48. This is possible because the optical fibers 2, 10 or 35 is generally made flexible. Or else, both the laser irradiating device 48 and the insulating substrate 46 may be moved to relatively scan the spot 50.

### Relationship Between the Laser Scanning Position And Display

FIG. 7 is a view shoeing the relationship between the laser scanning position and the display. Shown in FIG. 7 is (a) a display and (b) a mother glass comprising a plurality of displays.

In the present embodiment, a display comprises a plurality of picture elements 53A, an X driver circuit 55 driving the picture elements in the X direction, and an Y driver circuit 56 driving the picture elements in the Y direction. The X driver circuit 55 and the Y driver circuit 56 are required to be made of high quality TFTs, which means that they require to be made of high quality polysilicon.

The laser irradiating device and the laser irradiating method of the present embodiment is applicable to silicon modification of the above X driver circuit and Y driver circuit. The linear laser spot 57, 58 scans (59,60) on the positions on which the X driver circuit 55 and the Y driver circuit 56 are to be formed. The scanning may be done several times to form one driver circuit. It is efficient to conduct silicon modification by scanning (62,63,64,65) the linear laser spot on the mother glass 52 on which the display 53 is formed.

### Description of System On Glass

FIG. 8 is a view showing a system on glass. The system on glass comprises an X driver circuit 67 and a Y driver circuit 68 as well as highly integrated circuits such as control circuit 69, an interface circuit 70, memory circuit (not shown), computing circuit 71, in a similar way to those shown in FIG. 9. As these highly integrated circuits require to be made of high quality polysilicon, they can be made by the same way as in the above-described silicon modification of the X driver circuit and the Y driver circuit.

In the present embodiment, the insulating layer may be made of silica glass, non-alkali glass, plastic substrate or flexible plastic sheet. The device and method of the present embodiment is applicable to, not only a crystal display, but also an EL (Electro Luminescence) display.

The laser irradiating device and the laser irradiating method of the present embodiment enables it to highly densify light energy by effectively concentrating laser beams emitted from numerous low output blue semiconductor laser elements using optical fibers. By bundling one ends (opposite to the laser output end) of the optical fibers are in a line, it is possible to easily obtain high density linear laser output. By processing this laser output in the optical compensator and the objective lens, it is possible to form a high density linear laser spot having a laser intensity distribution with its top flatten.

The laser irradiating device and the laser irradiating method of the present embodiment enables it to form on the silicon layer a linear laser spot having a lateral length of 1 to 30 um and a longitudinal length of 1 to 30 mm, which is a suitable and practical laser spot for modification. It is also possible to stabilize the modification process because it is possible to prevent the laser spot from being deformed even in case the distance between the silicon layer and the device varies.

Further, in the present embodiment, it is easy to separate the main beams (wavelength: 370 to 480 nm) for modifying silicon and the focusing beams for obtaining the focusing signals, which enables reliable focus control and monitoring the change of the laser intensity distribution in the longitudinal direction of the linear laser spot. Also, by controlling the respective laser output in response to the change, it is possible to adjust the laser intensity distribution. As a consequence, it is possible to conduct silicon modification with high reliance and stability by maintaining the laser intensity distribution having it top flatten for a long time.

Further, in the present embodiment, it is possible to obtain a favorable silicon layer at a comparatively low cost by scanning the linear laser spot on the mother glass at a desired position, at a desired scanning speed, in a desired direction.

### BRIEF DESCRIPTION OF THE DRAWINGS

FIG. 1 A view of the basic construction of the laser irradiating device of the present invention.

FIG. 2 A view showing the focus controlling system of the laser irradiating device of the present invention.

FIG. 3 A view showing the spot rotation of the laser irradiating device of the present invention.

FIG. 4 A view showing the detection of the laser intensity distribution and the regulation of the laser output in the laser irradiating device of the present invention.

FIG. 5 A view showing the method of controlling laser intensity distribution in the laser irradiating device shown in FIG. 4.

FIG. 6 A view showing the laser irradiating method and manufacturing method of modifying amorphous silicon formed on a glass substrate of a liquid crystal display into polysilicon using the laser irradiating device of the present invention.

FIG. 7 A view shoeing the relationship between the laser scanning position and the display.

FIG. 8 A view showing a system on glass.

FIG. 9 A view showing a general substrate construction and modification of silicon layer by laser irradiation.

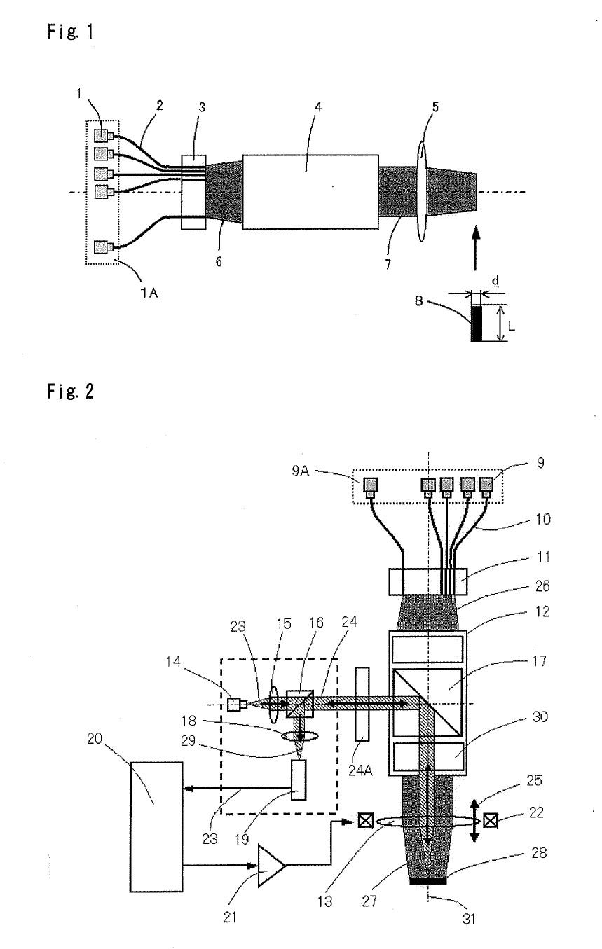

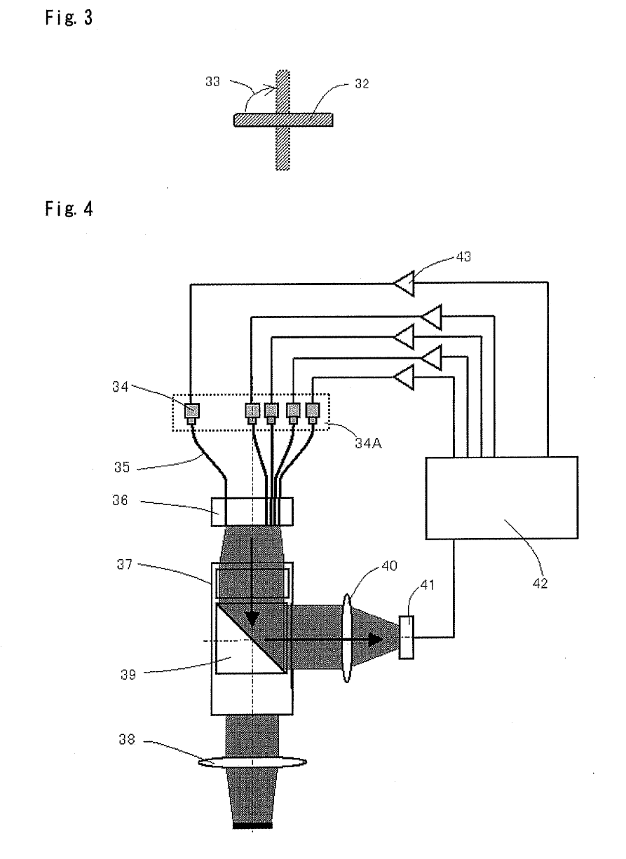

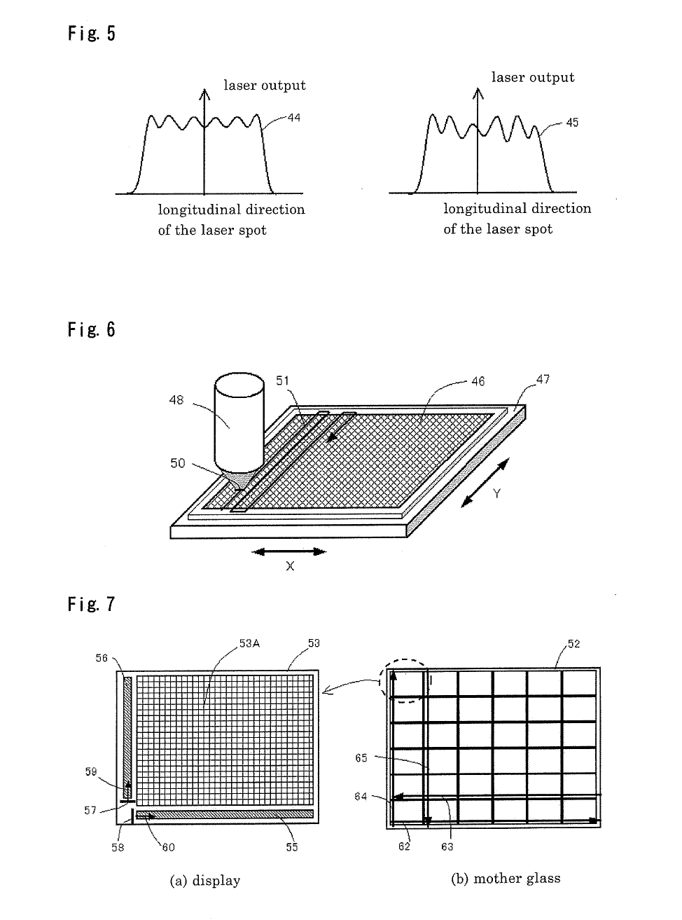

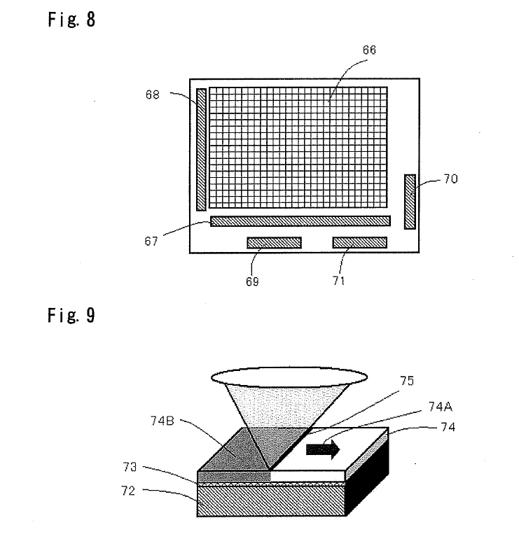

### DESCRIPTION OF REFERENCE NUMERALS

1: semiconductor laser element, 2: optical fiber, 3: linear bundle, 4: optical compensator, 5: objective lens, 6: laser beam, 7: laser beam, 8: linear laser spot, 9: semiconductor laser element, 10: optical fiber, 11: linear bundle, 12: optical compensator, 13: objective lens, 14: focusing semiconductor laser element, 15: collimating lens, 16: polarized beam splitter, 17: beam splitter, 18: convex lens, 19: focusing signal generator, 20: phase compensating circuit, 21: driver, 22: laser bema, 23: focusing error signal, 24: parallel beam, 24A: wavelength splitting plate, 26: main laser system, 28: linear laser beam, 29: laser beam, 30: spot rotator, 31: optical axis, 32: linear laser spot, 33: angle, 34: semiconductor laser element, 35: optical fiber, 36: linear bundle, 37: optical compensator, 38: objective lens, 39: beams splitter, 40: collimating lens, 41: line sensor, 42: microprocessor, 43: laser driver, 44: laser intensity distribution, 45: laser intensity distribution, 46: insulating layer, 47: stage, 48: laser irradiating device, 50: linear laser spot, 52: mother glass, 53: display, 53A: pixel, 55: X driver circuit, 56: Y driver circuit, 57: linear laser spot, 67: driver circuit, 68: driver circuit, 69: control circuit, 70: interface circuit, 71: computing circuit, 72: insulating layer, 73: undercoat layer, 75: linear laser beam, 74 amorphous silicon layer surface, 74B: polysilicon.

1. A laser irradiating device for modifying an object by irradiating laser beams thereon comprising:
a semiconductor laser element assembly having a plurality of first semiconductor laser elements emitting laser beams of a wavelength of 370 to 480 nm, said semiconductor laser element assembly irradiating a linear laser spot having a total irradiation output volume of 6 W or more and 100 W or less.

2. The laser irradiating device as set forth in claim 1 further comprising:
optical fibers transmitting laser beams emitted from said first semiconductor laser elements;
a linear bundle aligning and retaining said optical fibers on a line parallel to the longitudinal direction;
an optical compensator shaping the laser beams emitted from said optical fibers into a linear form, flattening the laser intensity distribution of the laser beams and emitting the laser beams; and
an objective lens collimating the laser beams emitted from said optical compensator to form a linear laser spot.

3. The laser irradiating device as set forth in claim 2, wherein said optical compensator and said objective lens operates such that a linear laser spot having a lateral length of 1 to 30 um and a longitudinal length of 1 to 30 mm is formed on the object.

4. The laser irradiating device as set forth in claim 1, further comprising:
focus error signal generating means generating focus error signals based on the laser beams returned from the linear laser spot irradiated on the object; and
an objective lens driving circuit driving said objective lens in the direction perpendicular to the surface of the object.

5. The laser irradiating device as set forth in claim 4, wherein said focus error signal generating means comprises second semiconductor laser elements emitting focusing laser beams having a wavelength of 500 to 900 nm.

6. The laser irradiating device as set forth in claim 1, further comprising:
laser intensity distribution detecting means disposed the light path of said linear laser spot to detect laser intensity distribution of said linear laser spot;
a laser driver regulating the laser output volume of said first semiconductor laser elements; and
controlling means controlling said laser driver such that the laser intensity distribution detected in said laser intensity distribution detecting means falls within a predetermined range.

7. The laser irradiating device as set forth in claim 6, wherein said controlling means comprises a pulse output controlling function to control said first semiconductor laser elements to output pulsed laser beams,
said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

8. The laser irradiating device as set forth in claim 1, further comprising:
laser spot rotating means rotating the linear laser spot irradiated on the object within an angle range of 0 to 90 degrees.

9. The laser irradiating device as set forth in claim 1, further comprising:
scanning means scanning the linear laser spot irradiated on the object relatively with respect to the surface of the object.

10. The laser irradiating device as set forth in claim 1, wherein the object is a thin film transistor for a display in which amorphous silicon formed on a glass substrate is modified into polysilicon.

11. A laser irradiating method for modifying an object by irradiating thereon linear laser spot emitted from a laser irradiating device comprising a semiconductor laser element assembly having a plurality of first semiconductor laser elements emitting laser beams of a wavelength of 370 to 480 nm,
wherein said semiconductor laser element assembly irradiates a linear laser spot having a total irradiation output volume of 6 W or more and 100 W or less.

12. The laser irradiating method as set forth in claim 11, wherein
said laser irradiating device further comprises optical fibers transmitting laser beams emitted from said first semiconductor laser elements, a linear bundle aligning and retaining said optical fibers on a line parallel to the longitudinal direction, an optical compensator shaping the laser beams emitted from said optical fibers into a linear form, flattening the laser intensity distribution of the laser beams and emitting the laser beams, and an objective lens collimating the laser beams emitted from said optical compensator to form a linear laser spot,
said optical fibers transmitting laser beams emitted from said first semiconductor laser elements to said optical compensator by way of said optical fibers retained by said linear bundle,
said optical compensator shaping the laser beams emitted from said optical fibers into a linear form, flattening the laser intensity distribution of the laser beams and emitting the laser beams to said objective lens,
said objective lens collimating the laser beams emitted from said optical compensator to form a linear laser spot, whereby the object is modified.

13. The laser irradiating method as set forth in claim 12, wherein said optical compensator and said objective lens operates such that a linear laser spot having a lateral length of 1 to 30 um and a longitudinal length of 1 to 30 mm is formed on the object, whereby the object is modified.

14. The laser irradiating method as set forth in claim 13, wherein
said laser irradiating device further comprises focus error signal generating means generating focus error signals based on the laser beams returned from the linear laser spot irradiated on the object and an objective lens driving circuit driving said objective lens in the direction perpendicular to the surface of the object,
said laser irradiating device further comprises focus error signal generating means generating focus error signals based on the laser beams returned from the linear laser spot irradiated on the object,
said objective lens driving circuit driving said objective lens in the direction perpendicular to the surface of the object, whereby the object is modified.

15. The laser irradiating method as set forth in claim 14, wherein
said laser irradiating device further comprises focus error signal generating means having second semiconductor laser elements,
said focus error signal generating means operates to control the focusing using the focusing laser beams having a wavelength of 500 to 900 nm emitted by said second semiconductor laser elements, whereby the object is modified.

16. The laser irradiating method as set forth in claim 15, wherein
said laser irradiating device further comprises laser intensity distribution detecting means disposed the light path of said linear laser spot to detect laser intensity distribution of said linear laser spot, a laser driver regulating the laser output volume of said first semiconductor laser elements and controlling means controlling said laser driver such that the laser intensity distribution detected in said laser intensity distribution detecting means falls within a predetermined range,
said laser intensity distribution detecting means detecting laser intensity distribution of said linear laser spot,
the laser driver regulating the laser output volume of said first semiconductor laser elements,
said controlling means controlling said laser driver such that the laser intensity distribution detected in said laser intensity distribution detecting means falls within a predetermined range, whereby the object is modified.

17. The laser irradiating method as set forth in claim 16, wherein
said laser irradiating device further comprises a pulse output controlling function to control said first semiconductor laser elements to output pulsed laser beams,
said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

18. The laser irradiating method as set forth in claim 11, wherein
said laser irradiating device further comprises laser spot rotating means rotating the linear laser spot irradiated on the object within a predetermined angle range,
said laser spot rotating means rotating the linear laser spot irradiated on the object within an angle range of 0 to 90 degrees, whereby the object is modified.

19. The laser irradiating method as set forth in claim 11, wherein
said laser irradiating device further comprises scanning means scanning the linear laser spot irradiated on the object relatively with respect to the surface of the object,
said scanning means scanning the linear laser spot irradiated on the object relatively with respect to the surface of the object, whereby the object is modified.

20. The laser irradiating method as set forth in claim 11, wherein the object is a thin film transistor for a display in which amorphous silicon formed on a glass substrate is modified into polysilicon.

21. A manufacturing method for manufacturing an object by irradiating laser beams thereon, wherein
using a semiconductor laser element assembly having a plurality of first semiconductor laser elements emitting laser beams of a wavelength of 370 to 480 nm,
said semiconductor laser element assembly irradiating a linear laser spot having a total irradiation output volume of 6 W or more and 100 W or less, whereby the object is modified.

22. The manufacturing method as set forth in claim 21, wherein
using optical fibers transmitting laser beams emitted from said first semiconductor laser elements, a linear bundle aligning and retaining said optical fibers on a line parallel to the longitudinal direction, an optical compensator shaping the laser beams emitted from said optical fibers into a linear form, flattening the laser intensity distribution of the laser beams and emitting the laser beams, and an objective lens collimating the laser beams emitted from said optical compensator to form a linear laser spot,
said optical fibers transmitting laser beams emitted from said first semiconductor laser elements to said optical compensator by way of said optical fibers retained by said linear bundle,
said optical compensator shaping the laser beams emitted from said optical fibers into a linear form, flattening the laser intensity distribution of the laser beams and emitting the laser beams to said objective lens,
said objective lens collimating the laser beams emitted from said optical compensator to form a linear laser spot.

23. The manufacturing method as set forth in claim 22, wherein
said optical compensator and said objective lens operates such that a linear laser spot having a lateral length of 1 to 30 um and a longitudinal length of 1 to 30 mm is formed on the object.

24. The manufacturing method as set forth in claim 21, wherein
using focus error signal generating means generating focus error signals based on the laser beams returned from the linear laser spot irradiated on the object and an objective lens driving circuit driving said objective lens in the direction perpendicular to the surface of the object,
said laser irradiating device further comprises focus error signal generating means generating focus error signals based on the laser beams returned from the linear laser spot irradiated on the object,
said objective lens driving circuit driving said objective lens in the direction perpendicular to the surface of the object.

25. The manufacturing method as set forth in claim 21, wherein
said laser irradiating device further comprises focus error signal generating means having second semiconductor laser elements having a wavelength of 500 to 900 nm,
said focus error signal generating means operates to control the focusing using the focusing laser beams having a wavelength of 500 to 900 nm emitted by said second semiconductor laser elements.

26. The manufacturing method as set forth in claim 21, wherein
said laser irradiating device further comprises laser intensity distribution detecting means disposed the light path of said linear laser spot to detect laser intensity distribution of said linear laser spot, a laser driver regulating the laser output volume of said first semiconductor laser elements and controlling means controlling said laser driver such that the laser intensity distribution detected in said laser intensity distribution detecting means falls within a predetermined range,
said laser intensity distribution detecting means detecting laser intensity distribution of said linear laser spot,
the laser driver regulating the laser output volume of said first semiconductor laser elements,
said controlling means controlling said laser driver such that the laser intensity distribution detected in said laser intensity distribution detecting means falls within a predetermined range.

27. The manufacturing method as set forth in claim 26, wherein
said pulse output controlling function is a function to control said laser driver such that the pulsed laser beams have a frequency of 0.1 to 5 MHz, a pulse duty ratio of 10 to 90% and a ratio (Pb/Pt×100) of the pulse top output (Pt) and the pulse bottom output (Pb) of 50% or less.

28. The manufacturing method as set forth in claim 21, wherein
said laser irradiating device further comprises laser spot rotating means rotating the linear laser spot irradiated on the object within a predetermined angle range,
said laser spot rotating means rotating the linear laser spot irradiated on the object within an angle range of 0 to 90 degrees.

29. The manufacturing method as set forth in claim 21, wherein
said laser irradiating device further comprises scanning means scanning the linear laser spot irradiated on the object relatively with respect to the surface of the object,
said scanning means scanning the linear laser spot irradiated on the object relatively with respect to the surface of the object.

30. The manufacturing method as set forth in claim 21, wherein the object is a thin film transistor for a display in which amorphous silicon formed on a glass substrate is modified into polysilicon.

31. A laser irradiating device for modifying amorphous silicon layer having a depth by irradiating laser beams thereon comprising:
a semiconductor laser element assembly having a plurality of semiconductor laser elements emitting laser beams having an optical penetration depth substantially equivalent to the depth of said amorphous silicon layer,
said semiconductor laser element assembly irradiating a linear laser spot having a total irradiation output volume of 6 W or more and 100 W or less.

32. A laser irradiating method using a laser irradiating device for modifying amorphous silicon layer having a depth by irradiating laser beams thereon wherein,
said laser irradiating device comprises a semiconductor laser element assembly having a plurality of semiconductor laser elements emitting laser beams having an optical penetration depth substantially equivalent to the depth of said amorphous silicon layer,
said semiconductor laser element assembly irradiating a linear laser spot having a total irradiation output volume of 6 W or more and 100 W or less on the amorphous silicon layer.

33. A manufacturing method for manufacturing an object having a layer depth by modifying said object by irradiating laser beams thereon, wherein
using a semiconductor laser element assembly having a plurality of semiconductor laser elements emitting laser beams having an optical penetration depth substantially equivalent to the depth of said amorphous silicon layer,
said semiconductor laser element assembly irradiating a linear laser spot having a total irradiation output volume of 6 W or more and 100 W or less on the object.
